(19) United States
(12) Patent Application Publication
(10) Pub. No.: US 2007/0291356 A1
(43) Pub. Date: Dec. 20, 2007

(54) Polarization separating film and backlight unit including the same

(75) Inventors: Jee-hong Min, Yongin-si (KR); Seong-mo Hwang, Yongin-si (KR); Young-chan Kim, Yongin-si (KR); Seung-ho Nam, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/711,055

(22) Filed: Feb. 27, 2007

(30) Foreign Application Priority Data
Jun. 14, 2006 (KR) 10-2006-0053553

(51) Int. Cl. G02B 5/30

(52) U.S. Cl. 359/485

(57) ABSTRACT

A polarization separating film and a backlight unit including the same are provided. The polarization separating film includes a first layer including an entry surface through which light is incident, and formed of optically isotropic materials, a second layer formed on the first layer and formed of optically anisotropic materials, and a fine pattern formed between the first layer and the second layer, wherein first polarized light of the light is transmitted and second polarized light of the light perpendicular to the first polarized light is reflected.

### CROSS-REFERENCE TO RELATED PATENT APPLICATION

This application claims priority from Korean Patent Application No. 10-2006-0053553, filed on Jun. 14, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a polarization separating film according to its polarization and a backlight unit in which light efficiency is enhanced by including the polarization separating film.

2. Description of the Related Art

Flat displays are classified into self-emissive displays that use organic materials to emit light and display images, and non-emissive displays which receive light from an external source and display images. For example, liquid crystal displays (LCDs) are non-emissive displays. Accordingly, special light sources, such as backlight units, are required in LCDs.

Backlight units are classified into direct-light type units and edge-light emitting type units. In direct-light type units, a light source is positioned on a lower surface of an LCD. In edge-light emitting type units, a light source is positioned on one surface or both surfaces of an LCD. Direct-light type units are mainly used in large-scale displays such as LCD TVs since a light source can be positioned in a wide area effectively and freely. Edge-light emitting type units are mainly used in medium to small sized displays such as monitors or cellular phones since a light source is positioned on a limited position such as a side of a light guide plate to reduce a volume of the display.

In current LCDs, only about 5% of total light emitted from a light source is used to display images. Such low light efficiency is caused by optical absorption by a polarization plate and a color filter included in the LCDs. LCDs are manufactured using a method including the following operations: positioning two substrates, on each of which an electrode generating an electric field is formed, so as to face each other; and injecting liquid crystal materials between the two substrates. LCDs are devices in which states of liquid crystal molecules are changed by an electrical field generated by applying a voltage to two electrodes formed on the two substrates and thus images are displayed by changing a transmissivity of light according to the states of the liquid crystal molecules. That is, only light, which is linear-polarized in one direction, is used in an LCD since the LCD functions as a shutter passing or blocking light by changing a polarization direction of linear polarized light. LCDs include a polarization plate formed on both surfaces of the LCDs. The polarization plate applied to the LCDs is an absorption-type plate. That is, the polarization plate formed on both surfaces of the LCDs transmits polarized light in one direction and absorbs polarized light in another direction. Since an absorption-type plate absorbs about 50% of incident light, light efficiency of LCDs is low.

To overcome these problems, research is being conducted vigorously. This research concerns the substitution of an absorption-type plate or the conversion of light incident into a polarization plate so as to be polarized in the same direction as a polarization direction of a rear substrate positioned on a rear surface of an LCD, to thus improve light efficiency. For example, in edge-light emitting type units, a reflective polarization film having a multi-layer structure such as a dual brightness enhancement film (DBEF) is adhered to an LCD to improve light efficiency. However, in an LCD including an additional reflective polarization film, manufacturing costs rise. Accordingly, a backlight unit that can emit polarized light, and having high light efficiency and low manufacturing costs is required.

### SUMMARY OF THE INVENTION

The present invention provides a polarization separating film, which has a simple structure and in which polarization separation can be performed effectively, and a backlight unit including the polarization separating film.

According to an aspect of the present invention, there is provided a polarization separating film including: a first layer including an entry surface through which light is incident, and formed of optically isotropic materials; a second layer formed on the first layer and formed of optically anisotropic materials; and a fine pattern formed between the first layer and the second layer, wherein first polarized light of the light is transmitted and second polarized light of the light perpendicular to the first polarized light is reflected.

According to another aspect of the present invention, there is provided a polarization separating film including: a first layer including an entry surface through which light is incident, and formed of optically isotropic materials; a second layer formed on the first layer, and formed of optically anisotropic materials; a first fine pattern at an interface between the first layer and the second layer; a third layer formed on the second layer, and formed of optically isotropic materials; a fourth layer formed on the third layer, and formed of optically anisotropic materials; and a second fine pattern formed at an interface between the third layer and the fourth layer, wherein first polarized light of the light is transmitted, and second polarized light of the light perpendicular to the first polarized light is reflected.

According to another aspect of the present invention, there is provided a backlight unit including: a light source; a light guide plate which guides light emitted from the light source; and a polarization separating film formed on the light guide plate, and including a first layer formed of optically isotropic materials, a second layer formed on the first layer and formed of optically anisotropic materials, and a fine pattern formed at an interface between the first layer and the second layer.

According to another aspect of the present invention, there is provided a backlight unit including: A backlight unit including: a light source; a diffusion plate which diffuses light emitted from the light source; and a polarization separating film formed on the diffusion plate, and including a first layer formed of optically isotropic materials, a second layer formed on the first layer and formed of optically anisotropic materials, a first fine pattern formed at an interface between the first layer and the second layer, a third layer formed on the second layer and formed of optically isotropic materials, a fourth layer formed on the third layer and formed of optically anisotropic materials, and a second fine pattern formed at an interface between the third layer and the fourth layer.

### BRIEF DESCRIPTION OF THE DRAWINGS

The above and other features and aspects of the present invention will become more apparent by describing in detail exemplary embodiments thereof with reference to the attached drawings in which:

FIG. 1 is a sectional view illustrating a polarization separating film according to an exemplary embodiment of the present invention;

FIGS. 2A, 2B, and 2C are sectional views illustrating polarization separating films of comparative examples for comparison with the polarization separating film of FIG. 1;

FIG. 3 is a graph illustrating polarization separating efficiencies of the polarization separating film of FIG. 1 and the polarization separating films of the comparative examples illustrated in FIGS. 2A, 2B, and 2C according to respective incidence angles and angles of prism patterns;

FIG. 4 is a sectional view illustrating a polarization separating film according to another exemplary embodiment of the present invention;

FIG. 5 is a sectional view illustrating a backlight unit according to an exemplary embodiment of the present invention; and

FIG. 6 is a sectional view illustrating a backlight unit according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will convey the concept of the invention to those skilled in the art. In the drawings, the thickness of layers and region is exaggerated for clarity.

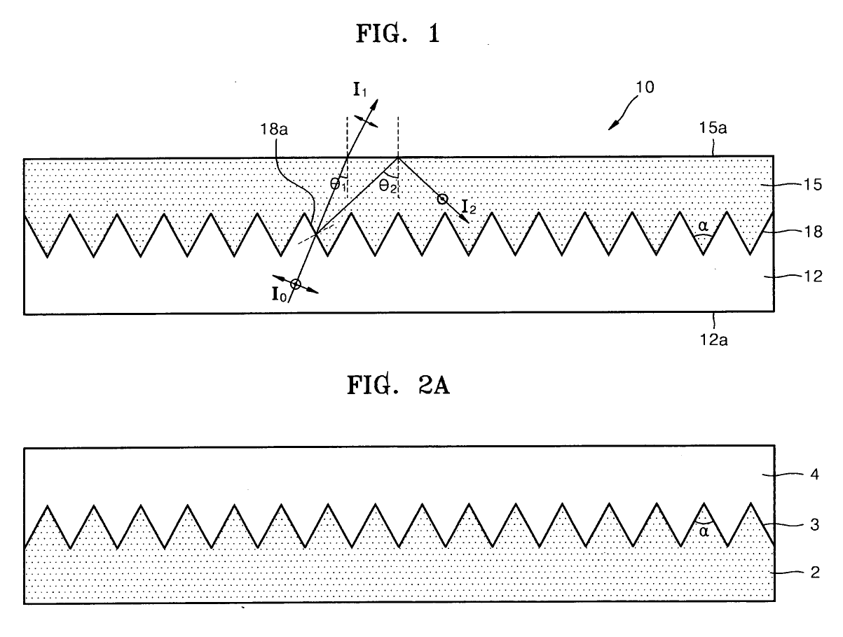

FIG. 1 is a sectional view illustrating a polarization separating film 10 according to an exemplary embodiment of the present invention. Referring to FIG. 1, the polarization separating film 10 includes a first layer 12 formed of optically isotropic materials, and a second layer 15 formed of optically anisotropic materials and positioned on the first layer 12. A fine pattern 18 is formed between the first layer 12 and the second layer 15. A lower surface 12a of the first layer 12 is an entry surface through which light is incident. The first layer 12 is formed of materials having a constant refractive index irrespective of a polarization direction of incident light. For example, the first layer 12 may be formed of PolyCarbonate (PC). The second layer 15 includes an exiting surface 15a through which light is emitted, and is formed of optically anisotropic materials having a different refractive index according to a polarization direction of incident light. For example, a refractive index of a first polarized light (I₁) in the second layer 15 may be almost the same as that in the first layer 12. A refractive index of a second polarized light (I₂) in the second layer 15 may be greater than that in the first layer 12. The first polarized light (I₁) may be P polarized light, and the second polarized light (I₂) may be S polarized light. The optically anisotropic materials may be PolyEthyleneNaphthalate (PEN). The fine pattern 18 is formed at an interface between the first layer 12 and the second layer 15. The fine pattern 18 is formed for separating incident light into the first polarized light (I₁) and second polarized light (I₂) so that the first polarized light (I₁) may be emitted from the exiting surface 15a and the second polarized light (I₂) may be totally reflected. For example, the fine pattern 18 may be a prism pattern of which apex angle is α.

The polarization separating film 10 having the structure as described above separates light according to a polarization direction as follows.

When light incident through the lower surface 12a of the first layer 12 arrives at the fine pattern 18, since the refractive index of the first layer 12 and that of the second layer 15 for the first polarized light (I₁) are same, the first polarized light (I₁) passes unaffected through the fine pattern 18 and arrives at the exiting surface 15a of the second layer 15 at an angle of θ₁ between the exiting surface 15a and a normal to the exiting surface 15a. Meanwhile, the refractive index of the second layer 15 is greater than that of the first layer 12 for the second polarized light (I₂), and thus the second polarized light (I₂) is refracted in a direction so that an angle between the second polarized light (I₂) and a normal to a first surface 18a of the fine pattern 18 becomes smaller, and arrives at the exiting surface 15a of the second layer 15 at an angle of θ₂ between the exiting surface 15a and a normal to the exiting surface 15a. Here, θ₂ is greater than θ₁. When an incident angle of light incident to the exiting surface 15a of the second layer 15 is greater than a critical angle, the incident light is totally reflected. When an incident angle of light incident to the exiting surface 15a of the second layer 15 is less than a critical angle, the incident light is refracted and emitted thorough the exiting surface 15a.

Meanwhile, at the exiting surface 15a of the second layer 15, critical angles of the first polarized light (I₁) and second polarized light (I₂) are as follows.

Since the second layer 15 is formed of optically anisotropic materials having a refractive index for the second polarized light (I₂) greater than that of the first layer 12, critical angle of the first polarized light (I₁) is greater than that of the second polarized light (I₂) at the exiting surface 15a. In addition, as described above, the incident angle (θ₁) of the first polarized light (I₁) at the exiting surface 15a of the second layer 15 is less than the incident angle (θ₂) of the second polarized light (I₂). Accordingly, the first polarized light (I₁) is almost refracted and emitted through the exiting surface 15a of the second layer 15. The second polarized light (I₂) is almost totally reflected at the exiting surface 15a.

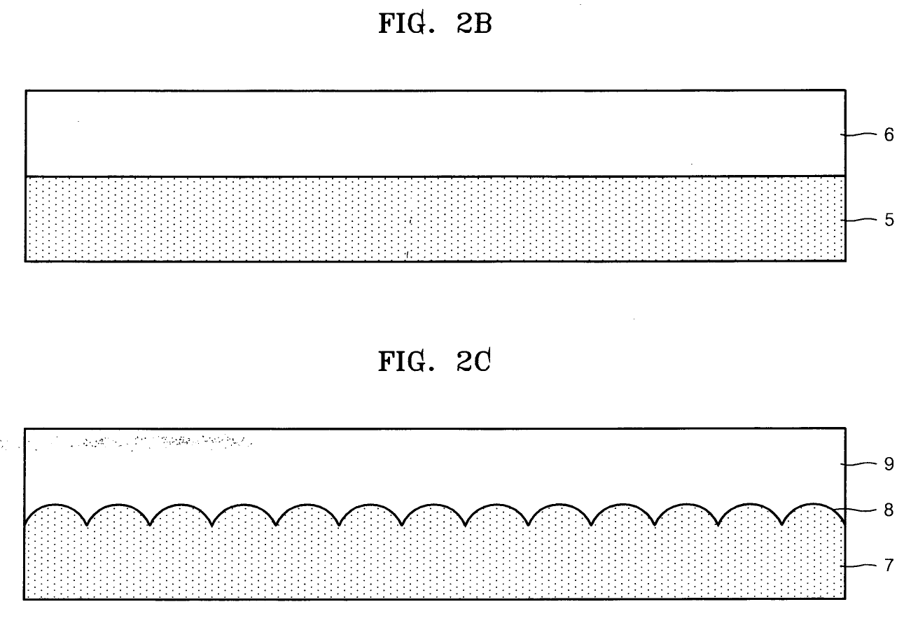

FIGS. 2A, 2B and 2C are sectional views illustrating polarization separating films of comparative examples for comparison with the polarization separating film 10 illustrated in FIG. 1 according to the current exemplary embodiment of the present invention.

Referring to FIG. 2A, a polarization separating film includes a first layer 2 formed of optically anisotropic materials and a second layer 4 formed of optically isotropic materials, and a prism pattern 3 of which apex angle is a formed at an interface between the first layer 2 and the second layer 4. Referring to FIG. 2B, a polarization separating film includes a first layer 5 formed of optically anisotropic materials, and a second layer 6 formed of optically isotropic materials. An interface between the first layer 5 and the second layer 6 is flat. That is, a fine pattern is not formed at the interface between the first layer 5 and the second layer 6. Referring to FIG. 2C, a polarization separating film includes a first layer 7 formed of optically anisotropic materials, a second layer 9 formed of optically isotropic materials, and a lens pattern 8 having a type of hemisphere pattern formed at an interface between the first layer 7 and the second layer 9.

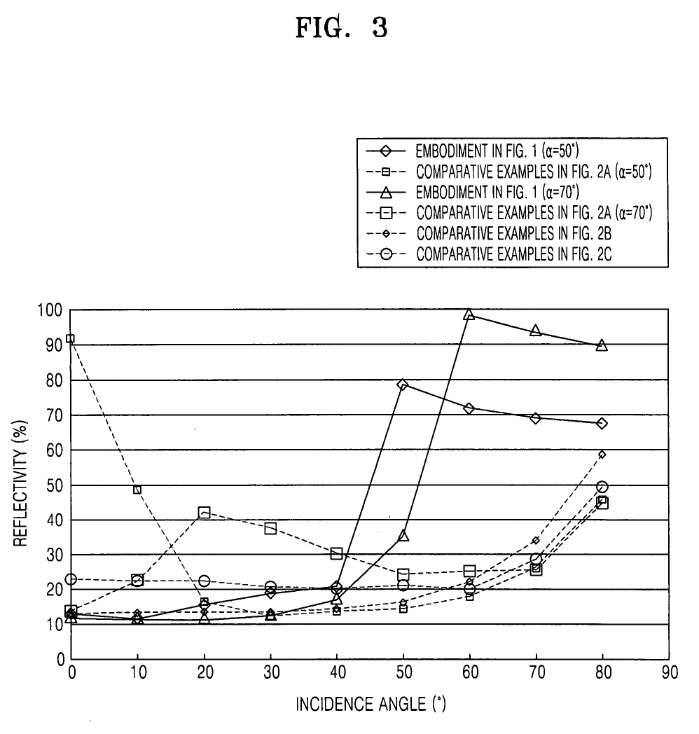

FIG. 3 is a graph illustrating polarization separating efficiencies of the polarization separating film 10 illustrated in FIG. 1 and the polarization separating films of the comparative examples illustrated in FIGS. 2A, 2B and 2C according to respective incidence angles and angles of prism patterns. Referring to FIG. 3, the polarization separating efficiencies of the comparative examples of FIGS. 2A, 2B and 2C and the polarization separating film 10 of FIG. 1 are illustrated in the case that respective apex angles of the prism patterns are 50° or 70°. Polarization separating efficiency is represented by reflectivity of S polarized light. In the comparative examples in FIGS. 2A, 2B and 2C, the reflectivity is less than 50% in almost all ranges of incident angles. On the other hand, in the polarization separating film 10 of FIG. 1, the reflectivity is greater than 60% when an incident angle is relatively great. In particular, when the apex angles of the prism patterns are 70°, the reflectivity in the comparative example in FIG. 2A and the polarization separating film 10 in FIG. 1 is greater than 90% when the incident angles are greater than 60°. From these results, it can be seen that the polarization separating film 10 according to the current exemplary embodiment of the present invention can be used in edge light-emitting type backlight units having an exiting angle of 60-80°, as a useful polarization separator.

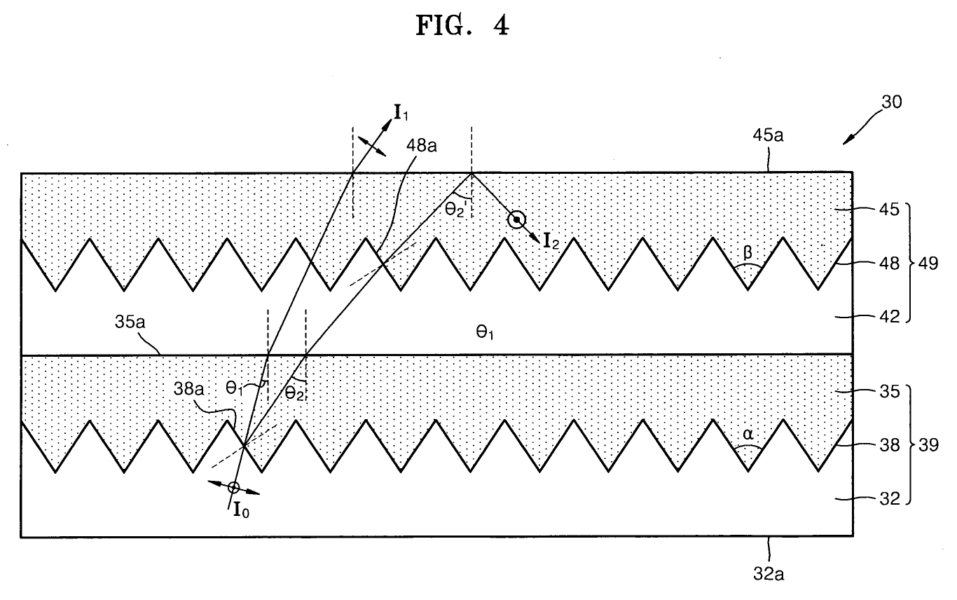

FIG. 4 is a sectional view illustrating a polarization separating film 30 according to another exemplary embodiment of the present invention. Referring to FIG. 4, the polarization separating film 30 according to the current exemplary embodiment of the present invention includes a first polarization separating film 39 and a second polarization separating film 49. The first polarization separating film 39 includes a first layer 32 formed of optically isotropic materials, a second layer 35 formed on the first layer 32 and formed of optically anisotropic materials, and a first fine pattern 38 formed at an interface between the first layer 32 and the second layer 35. The second polarization separating film 49 includes a third layer 42 formed on the second layer 35 and formed of optically isotropic materials, a fourth layer 45 formed on the third layer 42 and formed of optically anisotropic materials, and a second fine pattern 48 formed at an interface between the third layer 42 and the fourth layer 45. A lower surface 32a of the first layer 32 is an entry surface through which light is incident. The first layer 32 and the third layer 42 are formed of materials having a constant refractive index irrespective of a polarization direction of incident light. For example, the first layer 32 and the third layer 42 may be formed of PolyCarbonate (PC). The second layer 35 and the fourth layer 45 are formed of optically anisotropic materials having a different refractive index according to a polarization direction of incident light. For example, a refractive index of the second layer 35 for a first polarized light (I₁) is approximately the same as that of the first layer 32 and a refractive index of a fourth layer 45 for a first polarized light (I₁) is approximately the same as that of the third layer 42. The refractive index of the second layer 35 for a second polarized light (I₂) is greater than that of the first layer 32 and the refractive index of the fourth layer 45 for a second polarized light (I₂) is greater than that of the third layer 42. The first polarized light (I₁) may be P polarized light. The second polarized light (I₂) may be S polarized light. The optically anisotropic materials may be PolyEthyleneNaphthalate (PEN). The first fine pattern 38 and the second fine pattern 48 are formed for separating a path of light at the interfaces between the first layer 32 and second layer 35 and between the third layer 42 and fourth layer 45, respectively. For example, the first fine pattern 38 and the second fine pattern 48 may be prism patterns.

The polarization separating film 30 having the structure as described above separates light according to a polarization direction as follows.

Light is separated into the first polarized light (I₁) and the second polarized light (I₂). The first polarized light (I₁) and the second polarized light (I₂) arrive at an upper surface 35a of the second layer 35 with respective different incident angles θ₁ and θ₂ like FIG. 1. The second polarized light (I₂) is almost totally reflected at the upper surface 35a of the second layer 35, but some of the second polarized light (I₂) is refracted and transmitted into the third layer 42 when θ₂ is less than a critical angle Here, after being refracted at a second surface 48a of the second fine pattern 48, the second polarized light (I₂) refracted and transmitted into the upper surface 35a of the second layer 35 is incident to an exiting surface 45a of the fourth layer 45 with an incident angle of θ₂′. Here, θ₂′ is greater than θ₂. The second polarized light (I₂) may be totally reflected when θ₂′ is greater than a critical angle. That is, the first polarization separating film 39 separates again the light which is not separated by the second polarization separating film 49 to increase polarization separating efficiency. In addition, to increase polarization separating efficiency, the number of the polarization separating films may be three or more. Shapes of a fine pattern such as an apex angle of a prism pattern, etc. may be determined accordingly.

Table 1 shows the polarization separating efficiency of the polarization separating film 30 according to the current exemplary embodiment of the present invention according to a prism angle (α) of the first fine pattern 38 and a prism angle (β) of the second fine pattern 48. The polarization separating efficiency is represented by reflectivity and transmissivity of S polarized light. The first layer 32 and the third layer 42 are formed of PolyCarbonate (PC) which is an optically isotropic material having a refractive index of 1.59. The second layer 35 and the fourth layer 45 are formed of Poly Ethylene Naphthalate (PEN) having a refractive index for the first polarized light (I₁) of 1.59 and a refractive index for the second polarized light (I₂) of 1.82

TABLE 1

| | β = 50° | | β = 70° | | β = 90° | |
|---|---|---|---|---|---|---|
| | Transmissivity | Reflectivity | Transmissivity | Reflectivity | Transmissivity | Reflectivity |
| | (%) | (%) | (%) | (%) | (%) | (%) |
| α = 50° | 48.9 | 47.2 | 41.7 | 54.7 | 49.4 | 46.7 |
| α = 70° | 53.5 | 42.5 | 50.7 | 45.8 | 53.2 | 42.9 |
| α = 90° | 57.6 | 38.1 | 56.5 | 39.5 | 60.6 | 34.8 |

Referring to Table 1, the reflectivity slightly differs according to the prism angles (α) and (β). As the prism angle (α) of the first fine pattern 38 is smaller, the reflectivity is higher. The reflectivity is high when the prism angle (β) of the first fine pattern 38 is large and the prism angle (β) of the second fine pattern 48 is 70°. In particular, when α=50° and β=70°, the reflectivity is maximized, i.e. 54.7%.

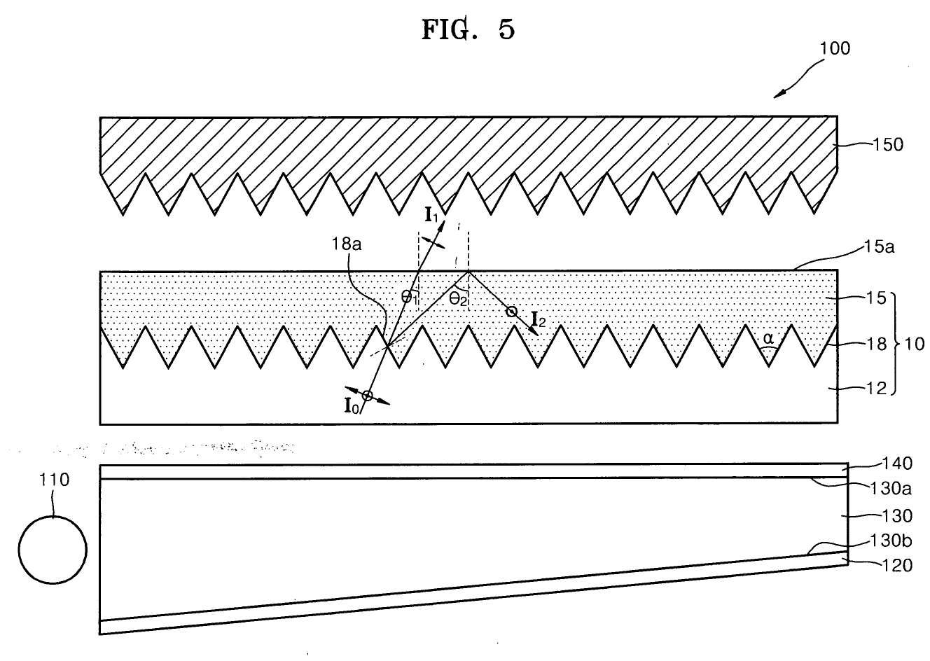

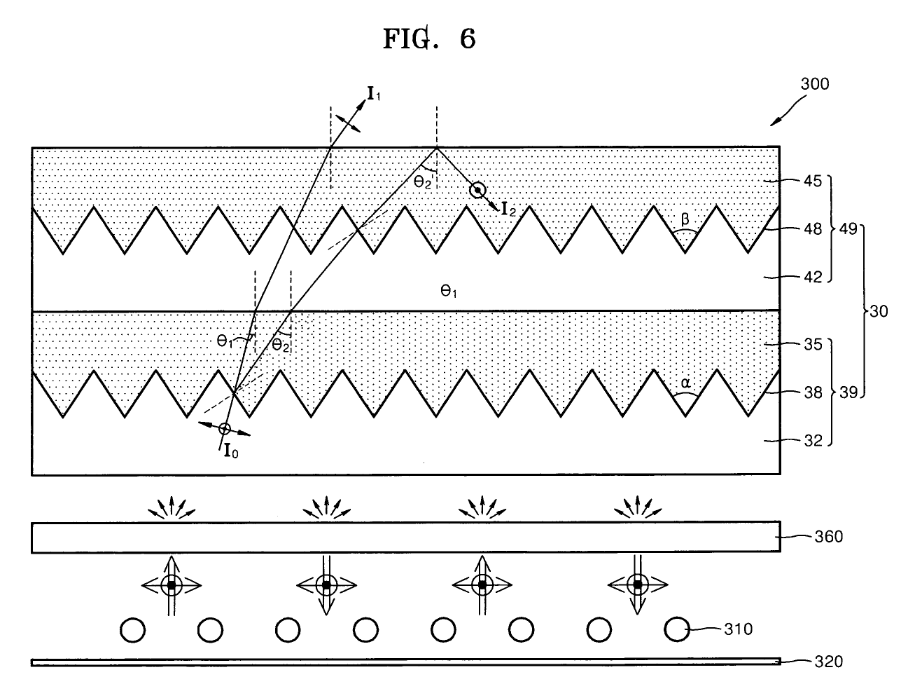

Both the polarization separating films 10 and 30 in FIGS. 1 and 4 may be used in a backlight unit, and thus remaining light which is not separated and emitted by the polarization separating films 10 and 30 may be incident into the polarization separating films 10 and 30 again. For example, the second polarized light (I₂) may be polarization transformed by a recycler and may be incident to the polarization separating films 10 and 30 again. This structure will be described with reference to FIG. 5 and FIG. 6 illustrating backlight units 100 and 300 respectively, according to exemplary embodiments of the present invention. That is, the backlight units 100 and 300 including the polarization separating films 10 and 30 have a greater reflectivity than that in Table 1.

Table 2 shows a total transmission quantity of P polarization and an increasing rate of illuminance gain according to a number of recycling, in consideration of an absorptance of a recycler. Table 2 shows that the backlight units 100 and 300 have improved brightness properties.

TABLE 2

| | | Total transmission quantity of P polarization % | | | |
|---|---|---|---|---|---|
| | | (Increasing rate of illuminance gain) | | | |
| S polarization | Absorptance | Number of | Number of | Number of | Number of |
| reflectivity (%) | (%) | recycling = 0 | recycling = 1 | recycling = 2 | recycling = 3 |
| 30% | 10% | 50.0 (1.00) | 56.8 (1.14) | 57.7 (1.15) | 57.7 (1.15) |
| | 20% | 50.0 (1.00) | 56.0 (1.12) | 56.7 (1.13) | 56.8 (1.14) |
| | 30% | 50.0 (1.00) | 55.3 (1.11) | 55.8 (1.12) | 55.8 (1.12) |
| 50% | 10% | 50.0 (1.00) | 61.3 (1.23) | 63.8 (1.26) | 64.0 (1.28) |
| | 20% | 50.0 (1.00) | 60.0 (1.20) | 62.0 (1.24) | 62.2 (1.24) |
| | 30% | 50.0 (1.00) | 58.8 (1.18) | 60.3 (1.21) | 60.4 (1.21) |
| 95% | 10% | 50.0 (1.00) | 71.4 (1.43) | 80.5 (1.61) | 80.7 (1.61) |
| | 20% | 50.0 (1.00) | 69.0 (1.38) | 76.2 (1.52) | 76.4 (1.53) |
| | 30% | 50.0 (1.00) | 66.0 (1.33) | 72.2 (1.44) | 72.2 (1.44) |

Table 2 shows the total transmission quantity of P polarization and the increasing rate of an illuminance gain according to the number of recycling when the reflectivity of the polarization separating film 30 according to the current exemplary embodiment of the present invention is each 30%, 50% and 95% based on a number of recycling being 0. The total transmission quantity of P polarization and the increasing rate of an illuminance gain are represented when the absorptance at recycling is each 10%, 20% and 30%. For example, when the absorptance is 20%, and S polarization reflectivity is 50%, the total transmission quantity of P polarization is 62.2%, and the increasing rate of illuminance gain is 1.24. As described in FIGS. 1 and 4, the S polarization reflectivity can be more than 50%, and thus the total transmission quantity of P polarization is greater than 62.2%, or the increasing rate of an illuminance gain is greater than 1.24. The S polarization reflectivity of 95% is the case when a dual brightness enhancement film (DBEF) is employed. For example, the increase of brightness when the S polarization reflectivity is 50% and the absorptance is 20% may be about half of the increase of brightness when the DBEF is employed.

FIG. 5 is a sectional view illustrating the backlight unit 100 according to an exemplary embodiment of the present invention. Referring to FIG. 5, the backlight unit 100 according to the current exemplary embodiment of the present invention is an edge light-emitting type backlight unit. The backlight unit 100 includes a light source 110, a light guide plate 130 guiding light emitted from the light source 110, and the polarization separating film 10 formed on the light guide plate 130.

Examples of the light source 110 may be a line source such as a cold cathode fluorescent lamp (CCFL) and a point source such as a light emitting diode (LED).

The light guide plate 130 guides light emitted from the light source 110 toward an upper surface 130a of the light guide plate 130, and may be formed of optically isotropic materials such as Polymethylmethacrylate (PMMA). The light guide plate 130 is a wedge type light guide plate, that is, the farther away from the light source 110, the distance between the upper surface 130a and a lower surface 130b is shorter. Alternatively, the light guide plate 130 may be a flat type light guide plate, that is, the distance between the upper surface 130a and the lower surface 130b is constant. The light emitted from the light source 110 is emitted directly to the upper surface 130a of the light guide plate 130, or is reflected by the lower surface 130b of the light guide plate 130 to be emitted toward the upper surface 130a. To enhance reflectivity of the lower surface 130b, the backlight unit 100 further includes a reflective plate 120 which reflects light toward the upper surface 130a and is formed on the lower surface 130b of the light guide plate 130.

The light which is emitted from the upper surface 130a of the light guide plate 130 and has an incident angle of about 60-80° arrives at the polarization separating film 10. The polarization separating film 10 illustrated in FIG. 5 is equivalent to the polarization separating film 10 illustrated in FIG. 1, and thus a detailed description thereof will be omitted. The polarization separating film 10 may have an S polarization reflectivity greater than 90% as described in FIG. 3. The light is separated by the polarization separating film 10 into first polarized light (I₁) and second polarized light (I₂). Then, the first polarized light (I₁) is emitted, and the second polarized light (I₂) is reflected back toward the light guide plate 130. The light is recycled. That is, the polarization direction of the light is changed or the light is changed into non-polarized light. Then the light is emitted to the upper surface 130a of the light guide plate 130 to be incident again to the polarization separating film 10 when the second polarized light (I₂) proceeds toward an inside of the light guide plate 130. The backlight unit 100 further includes a scattering sheet (140) formed on the upper surface 130a of the light guide plate 130 to enhance a recycling efficiency. The backlight unit 100 further includes a prism sheet 150 formed on the polarization separating film 10, and collimating the light polarization-separated in a direction perpendicular to the exiting surface 15a of the second layer 15. The S polarization reflectivity of the polarization separating film 10 of the backlight unit 100 having the above structure is greater than 90%, and thus the brightness of the backlight unit 100 may be as much as that of a backlight unit employing DBEF with reference to Table 2.

FIG. 6 is a sectional view illustrating a backlight unit 300 according to another exemplary embodiment of the present invention. Referring to FIG. 6, the backlight unit 300 according to the current exemplary embodiment of the present invention is a direct-light type backlight unit. The backlight unit 300 includes a reflective plate 320, a plurality of light sources 310 formed on the reflective plate 320, a diffusing plate 360 diffusing light emitted from the light sources 310, and the polarization separating film 30 formed on the diffusing plate 360.

Examples of the light source 310 may be a line source such as a cold cathode fluorescent lamp (CCFL), and a point source such as a light emitting diode (LED).

The reflective plate 320 reflects the light emitted from the light sources 310 forward to the diffusing plate 360, and the diffusing plate 360 diffuses the light so that the brightness of the light may be uniform.

The polarization separating film 30 shown in FIG. 6 is equivalent to the polarization separating film 30 in FIG. 4 and thus a detailed description thereof will be omitted. The light emitted from the diffusing plate 360 having an incident angle of 0-90° is incident to the polarization separating film 30. The light is separated into first polarized light (I₁) and second polarized light (I₂) by the polarization separating film 30. The first polarized light (I₁) proceeds upward, and the second polarized light (I₂) proceeds downward.

The light that proceeds downward is recycled as follows. The light has its polarization direction changed via the diffusing plate 360 and the reflective plate 320 and is incident again to the polarization separating film 30. By referring to the result of Table 1 showing the S polarization reflectivity of the polarization separating film 30 and the calculation result of Table 2 considering the number of recycling, it can be understood that backlight unit 300 having the above structure has an improved brightness property.

The polarization separating film according to the present invention including optically anisotropic materials and fine patterns may separate polarization of light using a simple and inexpensive method. That is, light can be separated according to a polarization using the polarization separating film manufactured using a simple method in which fine patterns are embossed on a surface of an anisotropic film. Thus, the polarization separating film according to the present invention has an effect of a larger cost reduction than, for example, a multi-layered structure such as DBEF. In addition, the polarization separating efficiency can be enhanced using the polarization separating film of the present invention including a plurality of layers formed of optically isotropic materials and a plurality of layers formed of optically anisotropic materials.

The polarization separating film according to the present invention may be used in edge light-emitting type backlight units or direct-light type backlight units. These backlight units have a high light efficiency, and thus can provide very bright light.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A polarization separating film comprising:
a first layer comprising an entry surface through which light is incident, and formed of optically isotropic materials;
a second layer formed on the first layer and formed of optically anisotropic materials; and
a fine pattern formed at an interface between the first layer and the second layer, wherein first polarized light of the light is transmitted and second polarized light of the light perpendicular to the first polarized light is reflected.

2. The polarization separating film of claim 1, wherein a refractive index of the first layer is the same as a refractive index of the second layer for the first polarized light.

3. The polarization separating film of claim 1, wherein the fine pattern is a prism pattern.

4. The polarization separating film of claim 3, wherein an apex angle of the prism pattern is greater than or equal to 50°.

5. A polarization separating film comprising:
a first layer comprising an entry surface through which light is incident, and formed of optically isotropic materials;
a second layer formed on the first layer, and formed of optically anisotropic materials;
a first fine pattern at an interface between the first layer and the second layer;
a third layer formed on the second layer, and formed of optically isotropic materials;
a fourth layer formed on the third layer, and formed of optically anisotropic materials; and
a second fine pattern formed at an interface between the third layer and the fourth layer, wherein first polarized light of the light is transmitted, and second polarized light of the light perpendicular to the first polarized light is reflected.

6. The polarization separating film of claim 5, wherein a refractive index of the first layer is the same as a refractive index of the second layer for the first polarized light.

7. The polarization separating film of claim 5, wherein a refractive index of the third layer is the same as a refractive index of the fourth layer for the first polarized light.

8. The polarization separating film of claim 5, wherein a refractive index of the first layer is the same as a refractive index of the second layer for the first polarized light, and a refractive index of the third layer is the same as a refractive index of the fourth layer for the first polarized light.

9. The polarization separating film of claim 5,
wherein the first fine pattern and the second fine pattern are each a prism pattern.

10. The polarization separating film of claim 9, wherein apex angles of the first fine pattern and second fine pattern are each less than or equal to 90°.

11. A backlight unit comprising:
a light source;
a light guide plate which guides light emitted from the light source; and
a polarization separating film formed on the light guide plate, and comprising a first layer formed of optically isotropic materials, a second layer formed on the first layer and formed of optically anisotropic materials, and a fine pattern formed at an interface between the first layer and the second layer.

12. The backlight unit of claim 11, wherein the first layer comprises an entry surface through which a light is incident, and a refractive index of the first layer is the same as a refractive index of the second layer for a first polarized light of the light.

13. The backlight unit of claim 11, further comprising:
a scattering sheet formed on the light guide plate.

14. The backlight unit of claim 11,
wherein the fine pattern is a prism pattern.

15. The backlight unit of claim 14,
wherein an apex angle of the prism pattern is greater than or equal to 50°.

16. A backlight unit comprising:
a light source;
a diffusion plate which diffuses light emitted from the light source; and
a polarization separating film formed on the diffusion plate, and comprising a first layer formed of optically isotropic materials, a second layer formed on the first layer and formed of optically anisotropic materials, a first fine pattern formed at an interface between the first layer and the second layer, a third layer formed on the second layer and formed of optically isotropic materials, a fourth layer formed on the third layer and formed of optically anisotropic materials, and a second fine pattern formed at an interface between the third layer and the fourth layer.

17. The backlight unit of claim 16, wherein the first layer comprises an entry surface through which a light is incident, and a refractive index of the first layer is the same as a refractive index of the second layer for a first polarized light of the light.

18. The backlight unit of claim 16, wherein the first layer comprises an entry surface through which a light is incident, and a refractive index of the third layer is the same as a refractive index of the fourth layer for a first polarized light of the light.

19. The backlight unit of claim 16, wherein the first layer comprises an entry surface through which a light is incident, and a refractive index of the first layer is the same as a refractive index of the second layer for a first polarized light of the light, and a refractive index of the third layer is the same as a refractive index of the fourth layer for the first polarized light.

20. The backlight unit of claim 16, wherein the first fine pattern and the second fine pattern are each a prism pattern.

21. The backlight unit of claim 20, wherein apex angles of the prism pattern included in the first fine pattern and the prism pattern included in the second fine pattern are each less than or equal to 90°.
